(19) United States
(12) Patent Application Publication
(10) Pub. No.: US 2004/0038692 A1
(43) Pub. Date: Feb. 26, 2004

(54) Interactive broadcast system

(76) Inventor: Saj Muzaffar, Hounslow Middlesex (GB)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/332,083

(22) PCT Filed: Jul. 3, 2001
(86) PCT No.: PCT/GB01/02987

(30) Foreign Application Priority Data
Jul. 4, 2000 (GB) 00162883

(51) Int. Cl. H04M 3/00

(52) U.S. Cl. 455/502; 455/418; 455/41.2

(57) ABSTRACT

A receiving arrangement for receiving a broadcast programme in interactive fashion comprises a television receiver and a wireless network device such as a WAP-enabled mobile telephone controlled by the recipient of the programee (i.e., the user). The user uses the wireless network device to generate and transmit digital data to the programme broadcaster in interactive fashion. For example, the broadcast programme may be a quiz show and the user may send answers to the quiz questions from the wireless network device. A WAP-enabled Internet site is hosted on a server and is synchronised with the broadcast programme.

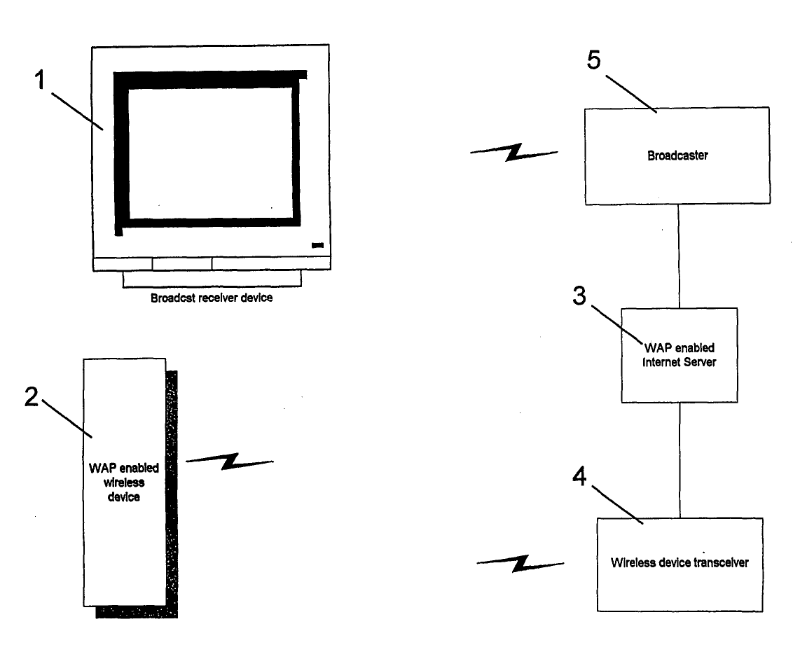

The present invention relates to a system, method and apparatus for interactive broadcasting, more particularly but not exclusively to interactive TV systems.

Interactive TV is conventionally carried out by a user being connected to the broadcaster by means of a set top box, which provides the user with interactivity using a remote control unit.

These conventional interactive broadcast (TV/radio) systems have restrictions and limitations; for example, additional equipment is needed, (e.g. a set top box) to receive the interactive program software and means to superimpose the user interaction interface (graphics and text) on top of or alongside a broadcast programme are also required.

Because of these requirements, only a small proportion of the population have the facility to receive TV or other broadcasts in interactive fashion.

An object of the present invention is to alleviate at least some of the above disadvantages.

According to one aspect of the invention, there is provided an interactive programme broadcast system comprising:

a broadcast transmitter;

computer apparatus coupled to the transmitter and operable for making available information related to and synchronised with the content of a programme broadcast by the transmitter; and

at least one user station including a broadcast receiver for receiving a programme broadcast by said transmitter, and a separate two-way digital wireless-communication network device operable independently of operation of said broadcast receiver for receiving digital signals indicative of the programme related information from the computer apparatus and for sending to the computer apparatus digital signals representing user responses entered via said device.

Preferably, said device is a mobile telephone, for example a WAP enabled mobile telephone or a mobile telephone operable to use packet-based transmission.

Said computer apparatus can comprise an Internet server and said device can be operable for communicating with the server via the Internet.

According to a second aspect of the invention, there is provided an interactive programme broadcasting method comprising broadcasting a programme via a transmitter to receivers at respective user stations and, using computer apparatus coupled to the transmitter, making available information related to and synchronised with the content of said programme for said information to be received at said user stations via respective two-way digital wireless-communication network devices, the devices being operable independently of operation of said receiver and said computer also being operated for receiving user responses entered via said devices.

According to a third aspect of the invention, there is provided transmitter apparatus for use in an interactive programme broadcast system having at least one user station that includes a broadcast receiver for receiving a broadcast programme and a separate two-way digital wireless-communication network device operable independently of said broadcast receiver, the apparatus comprising:—

broadcast transmitter for transmitting said programme: and

computer apparatus coupled to the transmitter and operable for making available to said device information related to and synchronised with the content of said programme, and for receiving digital signals representing user responses entered via said device.

The computer apparatus may comprise an Internet server arranged to host a time-coded Internet site which corresponds to the broadcast programme.

Preferably the wireless network device is hand-held.

Preferably the wireless network device is a mobile telephone, e.g. a WAP ′phone. In other embodiments the wireless network device could for example be a pager, PDA. Palm-top computer or other device having the facility to communicate over a communications network such as the Internet or public telephone system.

Because the wireless network device is distinct from (and bypasses) the programme receiver apparatus, the broadcast can be received by a conventional receiver apparatus, e.g. a conventional television.

Preferably the server is coupled to the Internet. Preferably the server is included in an arrangement for receiving WAP signals from programme recipients.

Preferably the wireless network devices are WAP ′phones.

There are many mobile telephones presently in use including WAP enabled telephones.

The WAP mobile phone is a wireless device that has the ability to view, access and interact with WAP enabled applications and services available on the Internet.

Just like Web pages on the Internet, WAP applications are written in a hypertext language and are available in the same manner and on the same computer servers (with some additional software) as Internet websites, and just like the Internet anyone with a WAP enabled device would be able to access a WAP website by typing in the web page address (e.g.www.playalong.com\wap).

One embodiment of the invention comprises a wireless interactive broadcast system that enables a user (i.e. recipient) to interact with a broadcast programme, available on a television, radio or other broadcast medium by using a WAP enabled wireless device that has the means to send, receive and display data related to a broadcast programme. The WAP enabled wireless device is operable by the user to interact simultaneously with said broadcast related data and the system includes means to compare said interaction with predefined interaction, e.g. answers to questions included in the broadcast programme.

For the purposes of this specification the word “interact” includes, but is not limited to mean participate, play along, (game show/quiz), request (services/goods), select, choose.

The wireless device may for example be connected to or be integral to may be a mobile phone, pager, PDA palm-top or any hand held device that has the means to display, send and receive data, (e.g. graphics and text) by means of a wireless communications.

The broadcast programme may for example be a game, game show, quiz, sports event, film, documentary, children's programme, advertisement or any broadcast programme a user could interact with.

In the case of a broadcast game show anyone with a suitable wireless device may be able to play along with the broadcast on his or her wireless device. The system may be arranged so that many players can compete against one another during a broadcast. In this case each player may be scored according to his accuracy and or speed of answering questions. Each player's score may then be transmitted back to the broadcaster or game operator in order to find a winner.

Players may be able to pre-book entry into a competition, wherein a short while before the broadcast begins the broadcaster send a SMS, page or other notification advising the player that a broadcast show is about to begin.

The wireless device may have the means to restrict access to the interactive services by means of a PIN (personal identification number) or other access control system or combination thereof.

A preferred embodiment of the present invention will now be described by way of example, only with reference to the accompanying drawing, which is a block diagram of interactive broadcasting apparatus.

In this embodiment, a user of a WAP enabled mobile phone is able to play along with a broadcast television quiz show. In order for this to be achieved, the questions and answers along with their time-codes (time lapsed from beginning) in the broadcast quiz show, would need to be available prior to the broadcast, for creating a WAP enabled interactive application of the broadcast quiz show, which would be simultaneously available on a WAP enabled Internet website, as the broadcast.

The apparatus comprises a broadcast receiver 1, in this example a television receiver 1 which provides the user with the means to view a broadcast programme. There are also a wireless device 2, in this example a WAP enabled mobile phone, to view and interact with a WAP enabled application, a WAP enabled Internet server 3, to host the said broadcast's WAP application, a wireless transceiver 4, to allow the WAP enabled wireless device 2 to connect, send and receive data from the WAP enabled server 3 available on the Internet, the broadcaster 6 who broadcasts the quiz show. This may be by means of a satellite, cable, ADSL or terrestrial transmission.

In this embodiment of the invention the user input and interacts by selecting the appropriate buttons by means of a keypad on the WAP enabled wireless device 2.

When a user of a WAP enabled wireless device 2 wants to interact, or play along, with the WAP enabled broadcast, in this example a quiz show; he inputs the Internet address of the quiz show's WAP enabled website, on his WAP enabled wireless device 2. The WAP enabled wireless device 2 then connects to the wireless device transceiver 4, which then connects the user to the quiz show's WAP enabled Internet website on the WAP enabled internet server 3.

Previous to the broadcast of the quiz show, the questions and answers along with their respective time-codes (time lapsed from the beginning), would be needed prior to the broadcast, so that a time coded WAP enabled internet application of the broadcast quiz show could be created. This would then be simultaneously running on the WAP enabled Internet server 3 as the broadcast of the quiz show: So that as the questions are announced on the broadcast quiz show, they simultaneously appear on the display of the WAP enabled wireless device 2. These questions may be available to the user as a multiple-choice interface, and as the answers are announced on the broadcast receiver 1, the user's selections are scored according to their accuracy.

When the broadcaster 5 starts to broadcast of the quiz show; the broadcaster 5 send a signal to the WAP enabled Internet server 3 to simultaneously run the broadcast related interactive WAP enabled application, on the WAP enabled Internet server 3. The broadcast and the Interactive WAP enabled application run simultaneously and synchronised.

As the questions become available to the user on television receiver 1, they are simultaneously displayed on the user's WAP enabled wireless device 2 via the WAP enabled Internet server 3. He may then answer the questions, which may be presented to him in a multiple-choice format.

In another embodiment of the present invention the complete WAP enabled application may be downloaded to the WAP enabled wireless device 2 prior to the broadcast. In this case the broadcaster would send a signal to the WAP Internet website instructing it to send a signal to the WAP enabled wireless device to begin the application, thereby synchronising it with the broadcast.

In another embodiment of the present invention the WAP enabled application may be download in sections, in this case, each time a section of the application is downloaded it is synchronised with the broadcast. This may happen at predefined time intervals in order to keep the WAP server synchronised with the broadcast.

Yet in another embodiment of the present invention the broadcast may be a radio broadcast.

This invention is not limited to WAP as new means of wireless communications are being developed which will become available, therefore consideration should be given to NTT′, DoCoMois, iMmode or the like, which are excellent WAP alternatives. Other new wireless communications that may be used include, but not limited to, Packet based wireless communications which will be introduced soon e.g. packet switched GPRS (GSM packet radio systems) and later Universal mobile telecommunications systems (UMTS).

These advances in wireless communications will mean faster data retrieval and transmission, with constant and immediate two-way data communications (“On-always”) which will not need to make a dial-up link every time data is sent or received.

Therefore in another embodiment of the present invention a user of a wireless device, with any one of the next generation of wireless communications, may have the means to interact with a broadcast, anytime without having to make a connection every time information or an interaction is required. In this case the broadcasters may by-pass the use of the Internet (WAP) and communicate directly with the wireless device. In another example of the present invention advertisements may be displayed on a users wireless device, these may be synchronised with broadcast advertisement or may be available independently (like banner advertising on the Internet). This feature could create a revenue stream for the operator (especially with the next generation of “On-always” wireless communications).

The interactive advertisements, available on the wireless device may be arranged so that a user may be able to purchase goods and/or services from a broadcast advertisement. The means to download vouchers may also be incorporated, i.e. if you watch/interact with an advertisement, a 25% off voucher is downloaded to your wireless device. This may then be printed off or redeemed by an electronic means (e.g. Bluetooth).

1. An interactive programme broadcast system comprising:
a broadcast transmitter;
computer apparatus coupled to the transmitter and operable for making available information related to and synchronised with the content of a programme broadcast by the transmitter; and
at least one user station including a broadcast receiver for receiving a programme broadcast by said transmitter, and a separate two-way digital wireless-communication network device operable independently of operation of said broadcast receiver for receiving digital signals indicative of the programme related information from the computer apparatus and for sending to the computer apparatus digital signals representing user reponses entered via said device.

2. A system according to claim 1, wherein said device is a mobile telephone.

3. A system according to claim 2, wherein the device is a WAP enabled mobile telephone.

4. A system according to claim 2, wherein the device is a mobile telephone operable to use packet-based transmission.

5. A system according to any preceding claim, wherein said computer apparatus comprises an Internet server and said device is operable for communicating with the server via the Internet.

6. An interactive programme broadcasting method comprising broadcasting a programme via a transmitter to receivers at respective user stations and, using computer apparatus coupled to the transmitter, making available information related to and synchronised with the content of said programme for said information to be received at said user stations via respective two-way digital wireless-communication network devices, the devices being operable independently of operation of said receiver and said computer also being operated for receiving user responses entered via said devices.

7. A method according to claim 6, wherein said computer apparatus is an Internet server and said information is made available via a WAP accessible Internet page.

8. A method according to claim 6, wherein said information is made accessible via packet-based radio communications devices.

9. A method according to claim 6, 7 or 8, wherein said user responses are compared with predefined values.

10. A method according to claim 9, wherein the programme includes setting one or more questions for the users, said method including comparing user responses with predetermined answers to said questions.

11. A method according to any one of claims 6 to 10, wherein advertisements are broadcast in the programme and said devices are arranged to carry corresponding interactive advertisements which enable the recipient to purchase the advertised goods or services.

12. Transmitter apparatus for use in an interactive programme broadcast system having at least one user station that includes a broadcast receiver for receiving a broadcast programme and a separate two-way digital wireless-communication network device operable independently of operation of said broadcast receiver, the apparatus comprising:
a broadcast transmitter for transmitting said programme; and
computer apparatus coupled to the transmitter and operable for making available to said device information related to and synchronised with the content of said programme, and for receiving digital signals representing user responses entered via said device.

13. Apparatus according to claim 12, wherein said device is a mobile telephone.

14. Apparatus according to claim 13, wherein the device is a WAP enabled mobile telephone.

15. Apparatus according to claim 13, wherein the device is a mobile telephone operable to use packet-based transmission.

16. Apparatus according to any one of claims 12 to 15, wherein said computer apparatus comprises an Internet server and said device is operable for communicating with the server via the Internet.

17. Apparatus according to claim 16, wherein the server is arranged to host a time-coded Internet site which corresponds to the broadcast programme.

18. Apparatus according to claim 14 which is arranged to download a WAP enabled application to the WAP telephones.

19. Apparatus according to claim 18, which is arranged to download a WAP enabled application in sections synchronised with the broadcast.

20. Apparatus according to any one of claims 12 to 19, further comprising means for comparing interactive responses from the recipients with a predefined interaction.

21. Apparatus according to claim 20, wherein the broadcast programme includes questions and the comparing means is arranged to receive answers from the recipients of the programme.
